(19) United States
(12) Patent Application Publication
(10) Pub. No.: US 2023/0162189 A1
(43) Pub. Date: May 25, 2023

(54) SHOPPING PLATFORM PROFIT SHARING SYSTEM

(71) Applicants: YI-HSUAN LEE, Taichung City (TW); YU-SHENG SU, Taichung City (TW)

(72) Inventors: YI-HSUAN LEE, Taichung City (TW); YU-SHENG SU, Taichung City (TW)

(21) Appl. No.: 17/953,249

(22) Filed: Sep. 26, 2022

Related U.S. Application Data
(63) Continuation-in-part of application No. 17/534,354, filed on Nov. 23, 2021, now abandoned.

(51) Int. Cl. G06Q 20/40; G06Q 30/02; G06Q 20/42

(52) U.S. Cl. CPC G06Q 20/4014; G06Q 30/0234; G06Q 20/42; G06Q 30/0226; G06Q 30/0233

(57) ABSTRACT

A shopping platform profit sharing system includes a user end and a server. The user end and the server are connected with each other by Internet. The server includes a database and a transaction management module. The database includes product information, member information and a link sharing generation unit. The transaction management module includes an identity verification unit, a link sharing confirmation unit, a shopping bonus calculation unit, and a rebate calculation unit. When the user end places an order to purchase a product by the transaction management module, the order is processed through the identity verification unit, the link sharing confirmation unit, the shopping bonus calculation unit and the rebate calculation unit to achieve a fair and reasonable shopping profit sharing feature.

### BACKGROUND OF THE INVENTION

### 1. Fields of the Invention

The present invention is a Continuation-In-Part patent application of applicant's former patent application with the application Ser. No. 17/534,354, filed on 23 Nov. 2021.

### 2. Descriptions of Related Art

In a multi-level marketing system, direct distributors use multi-level direct sales to distribute profits, so that the direct sales personnel of the upstream and downstream of the same line have a profit sharing mechanism. However, such multi-level direct sales behaviors, many products are priced and sold at high unit prices because the profit from the sale is shared by many sales personnel. Therefore, problems in the profit sharing system are often seen and cause bad affect to the people.

The multi-layered direct selling method causes the unit price of direct selling products to be high, which is not attractive. In order to comply with the legal norms of direct selling, many prevention mechanisms must be designed, which causes troubles for direct sellers.

Rolf discloses a method for developing a multilevel person to person affiliate marketing network using electronic communications, however, the system as disclosed by Rolf is similar the conventional multi-layered direct selling method, and may include many areas to be improved.

The present invention intends to provide a shopping platform profit sharing system that is fair and reasonable, and eliminates shortcomings mentioned above.

### SUMMARY OF THE INVENTION

The present invention relates to a shopping platform profit sharing system and comprises a user end and a server. The user end and the server are connected with each other by internet. The server includes comprises a database and a transaction management module. The database includes product information, member information and a link sharing generation unit. The transaction management module includes an identity verification unit, a link sharing confirmation unit, a shopping bonus calculation unit, and a rebate calculation unit. When the user end places an order to purchase a product by the transaction management module, the order is processed through the identity verification unit, the link sharing confirmation unit, the shopping bonus calculation unit and the rebate calculation unit to achieve a fair and reasonable shopping profit sharing feature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 discloses the block diagram of the shopping platform profit sharing system of the present invention;

FIG. 2 is a block diagram to show that a member purchases products from the shopping platform profit sharing system of the present invention;

FIG. 3 is a block diagram to show that an advanced member and a member are upstream and downstream partners, purchase products from the shopping platform profit sharing system of the present invention;

FIG. 4 is a block diagram to show that an advanced member and a member are upstream and downstream partners, purchase products from the shopping platform profit sharing system of the present invention via link sharing;

FIG. 5 is a block diagram to show that an advanced member and another advanced member are upstream and downstream partners, purchase products from the shopping platform profit sharing system of the present invention;

FIG. 6 is a block diagram to show that an advanced member and another advanced member are upstream and downstream partners, purchase products from the shopping platform profit sharing system of the present invention via link sharing;

FIG. 7 is a block diagram to show that an advanced member and a member are upstream and downstream partners, and another advanced member issues a link sharing to the member, and the member purchases products from the shopping platform profit sharing system of the present invention;

FIG. 8 is a block diagram to show that three advanced members, and two of the three advanced members are upstream and downstream partners, and another advanced member issues a link sharing to the downstream advanced member and the downstream advanced member purchases products from the shopping platform profit sharing system of the present invention;

FIG. 9 is a block diagram to show that two advanced members, and one of the two advanced members and a member are upstream and downstream partners, the non-upstream advanced member issues a link sharing to the member, and the member purchases products from the shopping platform profit sharing system of the present invention;

FIG. 10 is a block diagram to show that there are three advanced members, and two of the three advanced members are upstream and downstream partners, the third advanced member issues a link sharing to the downstream advanced member, the downstream advanced member purchases products one or more than one time from the shopping platform profit sharing system of the present invention, and

FIG. 11 is a block diagram to show that when an advanced member and a member are upstream and downstream partners, other advanced members issue a link sharing to the member, and the member purchases products one or more than one time from the shopping platform profit sharing system of the present invention.

### DETAILED DESCRIPTION OF THE PREFERRED EMBODIMENT

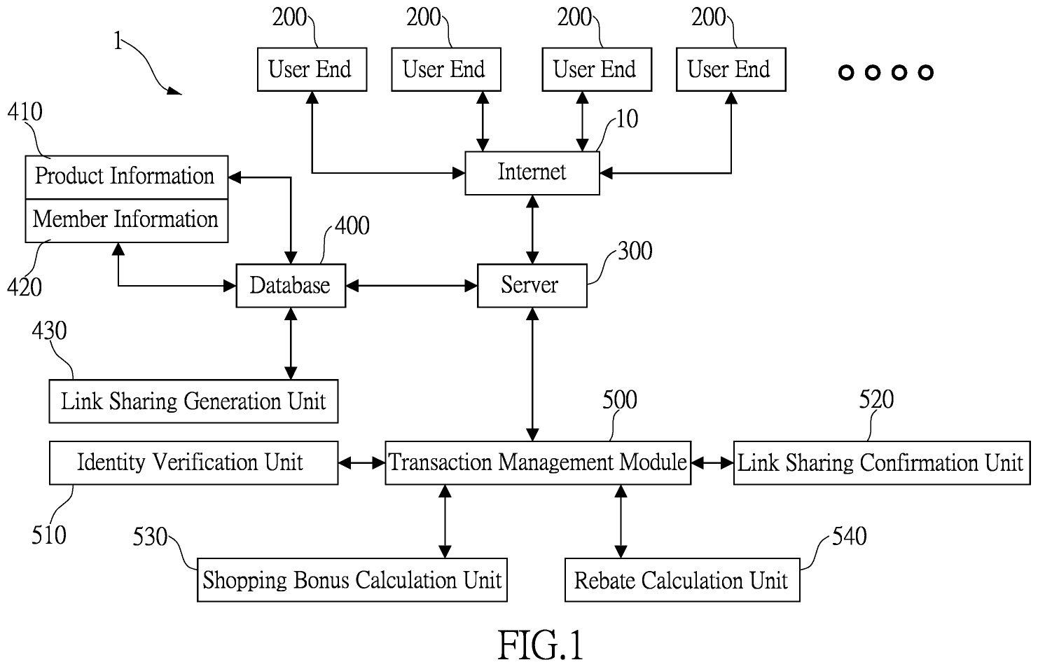

Referring to FIG. 1, the platform profit sharing system 1 of the present invention comprising a user end 200 and a server 300. The user end 200 and the server 300 are connected with each other by internet 10 so as to transmit data to each other. The server 300 comprises a database 400 and a transaction management module 500. The database 400 includes a product information 410, a member information 420 and a link sharing generation unit 430. The transaction management module 500 includes an identity verification unit 510, a link sharing confirmation unit 520, a shopping bonus calculation unit 530, and a rebate calculation unit 540. When the user end 200 places an order to purchase a product by the transaction management module 500, the order is checked, calculated and delivered through the identity verification unit 510, the link sharing confirmation unit 520, the shopping bonus calculation unit 530 and the rebate calculation unit 540.

The member information 420 includes a member information, and an advanced member information. When the user end 200 is a member, the identity verification unit 510 confirms whether the user end 200 matches with the member information, then the link sharing confirmation unit 520 confirms the match, and then the shopping bonus calculation unit 530 issues and adds a bonus point to the member information. When the user end 200 is an advanced member, the identity verification unit 510 confirms whether the user end 200 matches with the advanced member information, the link sharing confirmation unit 520 then confirms the match, and then the shopping bonus calculation unit 530 and the rebate calculation unit 540 issue and add a bonus point and a rebate point to the advanced member information.

The user end 200 can be a smart phone, a PC or a tablet operated by a member or an advanced member. Members are those who have registered on the shopping platform 20. Advanced members are those who are a host of a group, an influencer or a famous person who has granted by the administrator of the site and registered on the shopping platform 20, or the members who are promoted to be advanced members by way of payment or accumulation of rebate points on the shopping platform 20. It is noted that the members and the advanced members are directly registered on the shopping platform 20. Only the members and the advanced members are allowed to put orders and purchase product from the shopping platform profit sharing system.

For example, a member and an advanced member purchase products from the shopping platform 20, and bonus points and rebate points are generated via the shopping bonus calculation unit 530 and the rebate calculation unit 540 respectively, and stored in the member information. Assume that the product has 300 bonus value (the 300 bonus points can be a portion of the profit received from the sale of the product on the shopping platform 20), and 30 rebate points. The bonus points are minimum 4% and maximum 8% of the 300 bonus value of the product. The rebate points are 30 rebate value of the product. The bonus points and the rebate points are used to be accumulated for the members within a limit period of time. The rebate points provide the advanced members to have minimum 12% and maximum 35% when in calculation. The rebate points are used to set the proportion of different levels of performance, such as 12% (low standard), 25%, 28% and 35% (high standard), and to set the required rebate points of the purchase of products and required rebate points of self-purchased products for each level of the members (or via link sharing). The required rebate points mentioned above can be calculated monthly, quarterly or yearly. The bonus points can be redeemed when purchasing products on the shopping platform next time. The rebate points provide the members to be checked and promoted to be an advanced member by the administrator of the shopping platform 20. The rebate points can also be calculated as bonus to the advanced members, such as, each rebate point represents 10 dollars of bonus.

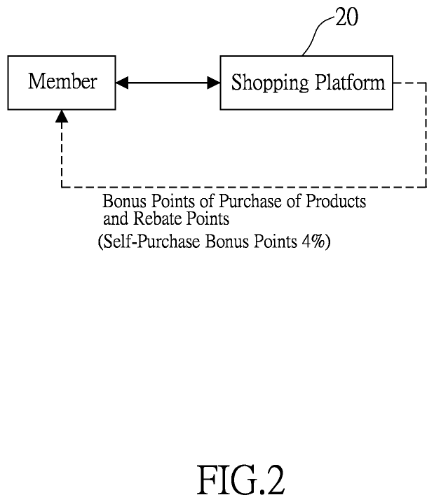

Referring to FIG. 2, when the member is not granted by the link sharing confirmation unit 520, the member receives 4% of the self-purchase bonus point from the shopping bonus calculation unit 530, that is 300×4%=12. The member receives 12 bonus points and 30 rebate value of the product.

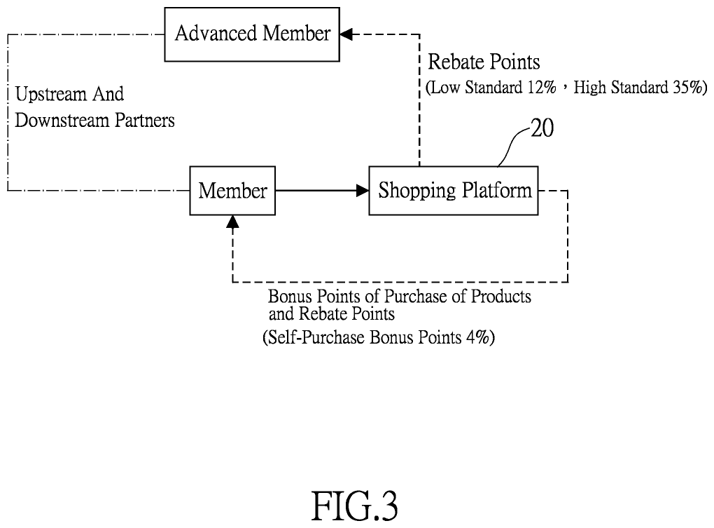

As shown in FIG. 3, when the member is not matched by the link sharing confirmation unit 520, the member receives 4% of the self-purchase bonus point (300×4%=12), and the member receives 12 bonus points and 30 rebate value of the product. When the advanced member and the member are upstream and downstream partners, the advanced member receives the rebate point from the rebate calculation unit 540. The advanced member receives 30 rebate points from the purchase of the member, so that the advanced member reaches the low standard and receives 3.6 rebate points (30×12%=3.6). If the advanced member reaches the high standard, the advanced member receives 10.5 rebate points (30×35%=10.5). The rebate points are deemed into bonus to the advanced member.

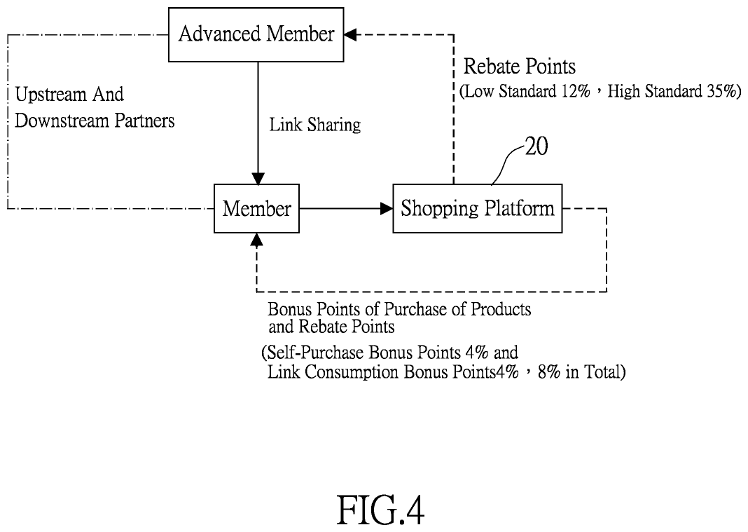

As shown in FIG. 4, when the advanced member operates the user end 200 at the link sharing generation unit 430 to generate a product link sharing including the product information and the advanced member information. The advanced member shares product link sharing with members of other user ends 200 via the internet. When the member is matched by the link sharing confirmation unit 520, the member receives 4% of self-purchased bonus point and 4% of link consumption bonus point (300×(4+4)%=24) from the shopping bonus calculation unit 530. The member also receives 30 rebate value of the product. When the advanced member and the member are upstream and downstream partners, the advanced member receives from minimum 12% (30×12%=3.6) to maximum 35% rebate points (30×35%=10.5) from the rebate calculation unit 540. The rebate points are deemed into bonus to the advanced member.

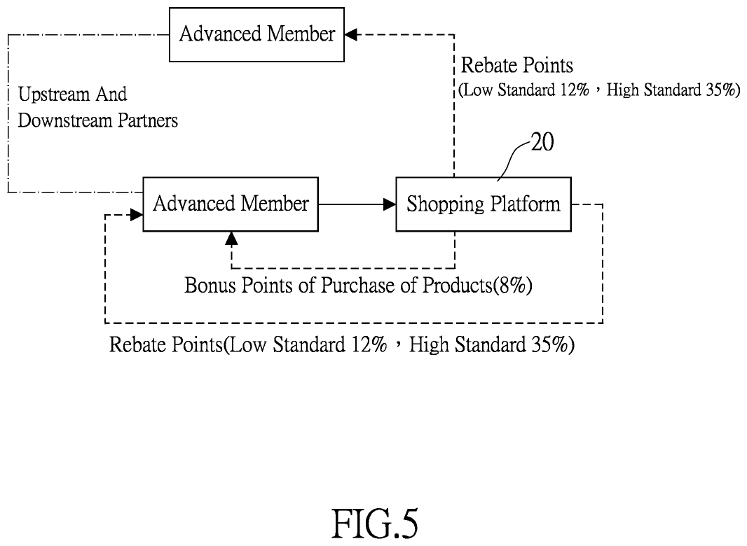

As shown in FIG. 5, when the advanced member (downstream advanced member) is no matched by the link sharing confirmation unit 520, the advanced member (downstream advanced member) receives 8% of self-purchase bonus points (300×8%=24) from the shopping bonus calculation unit 530. The advanced member (downstream advanced member) receives from minimum 12% (30×12%=3.6) to maximum 35% (30×35%=10.5) of rebate points from the rebate calculation unit 540. When the advanced member (downstream advanced member) is an advanced member of other user end 200, the advanced member (upstream advanced member) of said other user end 200 receives minimum 12% (30×12%=3.6) to maximum 35% (30×35%=10.5) of rebate points from the rebate calculation unit 540, and the rebate points are deemed into bonus to the advanced member.

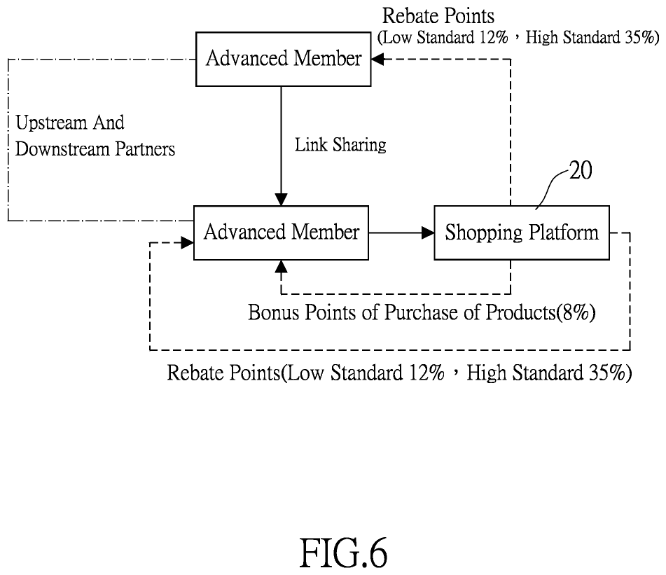

As shown in FIG. 6, when the advanced member (downstream advanced member) is matched by the link sharing confirmation unit 520, the advanced member (downstream advanced member) receives 8% of self-purchase bonus points (300×8%=24) from the shopping bonus calculation unit 530. The advanced member (downstream advanced member) receives from minimum 12% (30×12%=3.6) to maximum 35% (30×35%=10.5) of rebate points from the rebate calculation unit 540. When the advanced member is a downstream advanced member of other user end 200, the advanced member (upstream advanced member) of said other user end 200 receives from minimum 12% (30×12%=3.6) to maximum 35% (30×35%=10.5) of rebate points from the rebate calculation unit 540, and the rebate points are deemed into bonus to the advanced member (upstream advanced member).

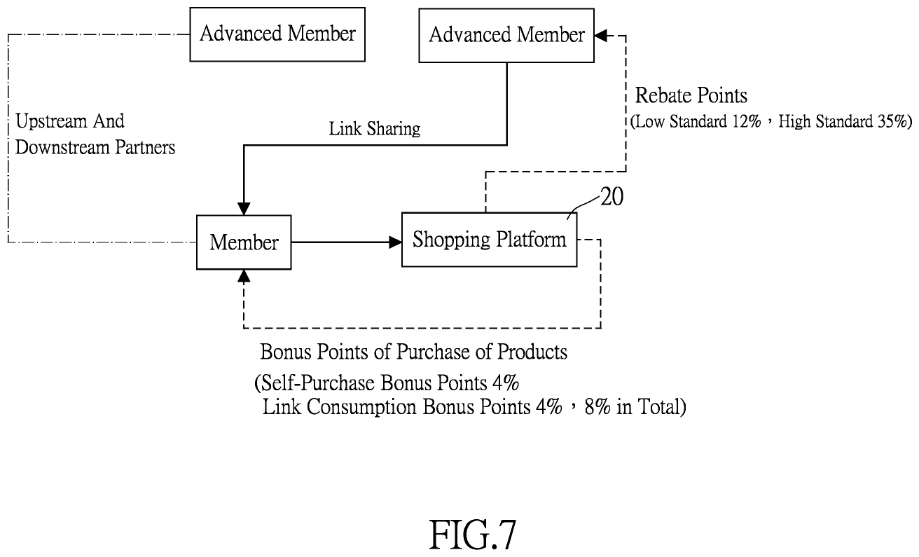

As shown in FIG. 7, when the member is matched by the link sharing confirmation unit 520, the member receives 4% of self-purchased bonus point and 4% of link consumption bonus point from the shopping bonus calculation unit 530 (300×(4+4)%=24). When the advanced member and the member are not upstream and downstream partners, the advanced member receives rebate point from minimum 12% (120×12%=3.6) to maximum 35% (30×35%=10.5) from the rebate calculation unit 540. The rebate points are deemed into bonus to the advanced member (the advanced member who sends the link shafting).

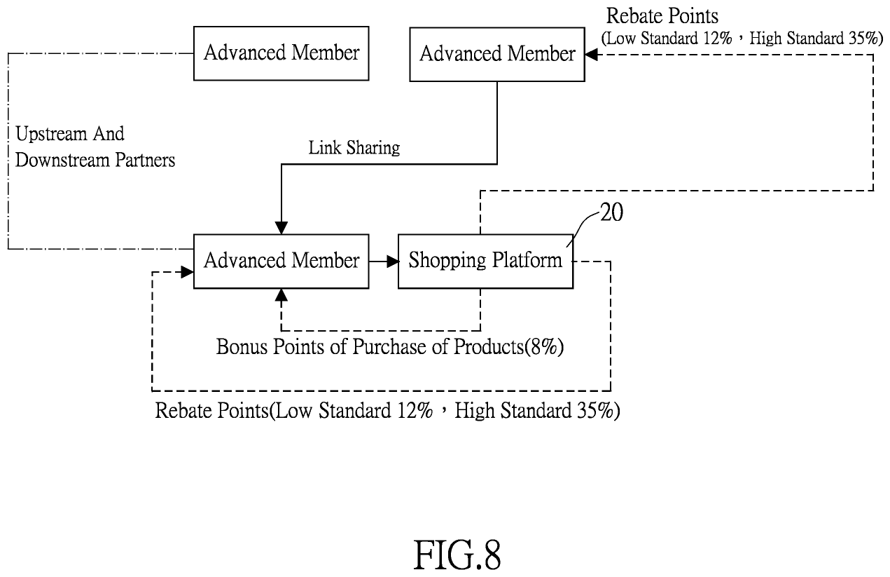

As shown in FIG. 8, when the advanced member (downstream advanced member) is matched by the link sharing confirmation unit 520, the advanced member (downstream advanced member) receives 8% of self-purchased bonus point (300×8%=3.6) from the shopping bonus calculation unit 530. The advanced member (downstream advanced member) receives rebate points from minimum 12% (120×12%=3.6) to maximum 35% (30×35%=10.5) from the rebate calculation unit 540. The rebate points are deemed into bonus to the advanced member (the downstream advanced member). When the advanced member is not a downstream advanced member of other user ends 200, the advanced member of said other user ends 200 receives rebate points from minimum 12% (30×12%=3.6) to maximum 35% (35×355=10.5) from the rebate calculation unit 540. The rebate points are deemed into bonus to the advanced member (the advanced member who sends the link shafting).

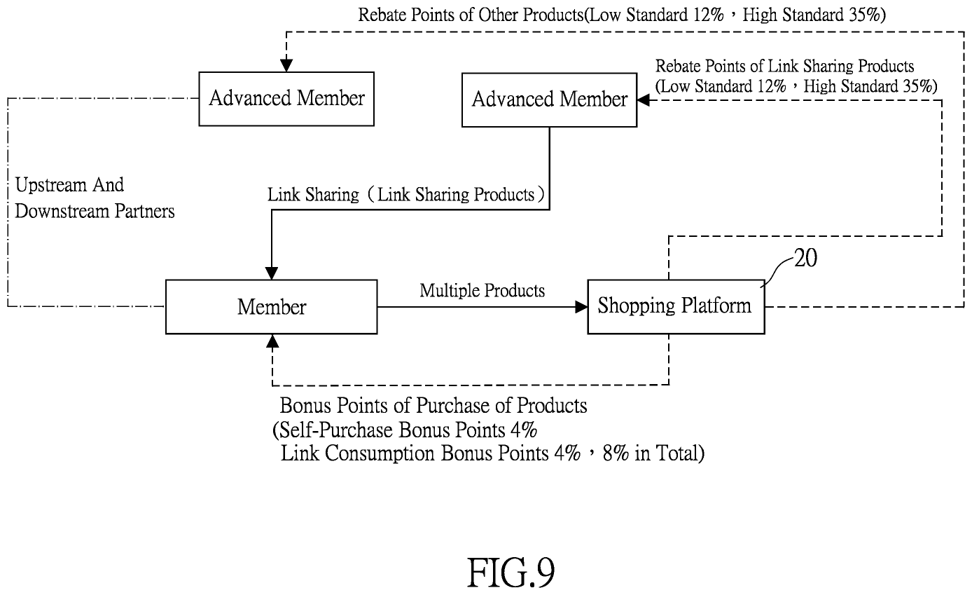

As shown in FIG. 9, when the advanced member and the member are upstream and downstream partners, and another advanced member sends a link sharing to the member, and the downstream purchases one product via the link shafting and one other product that are not involved in the link sharing from the shopping platform 20, the member receives 4% of the self-purchase bonus points and 4% of the link consumption bonus points (300×(4+4)%=24) from the shopping bonus calculation unit 530, and other product not involved in the link sharing link (300×4%=12). That is to say, the purchase of the two products in total receives 36 points of the bonus points. The advanced member who sends the link sharing receives rebate points because of the link sharing of the product from the rebate calculation unit 540 from minimum 12% (30×12%=3.6) to maximum 35% (30×35%=10.5). The upstream advanced member receives rebate points of the rest of the other product not involved in the link sharing link from minimum 12% (30×12%=3.6) to maximum 35% (30×35%=10.5) from the rebate calculation unit 540. The rebate points are deemed into bonus to the advanced member (the upstream advanced member, the advanced member who sends the link shafting).

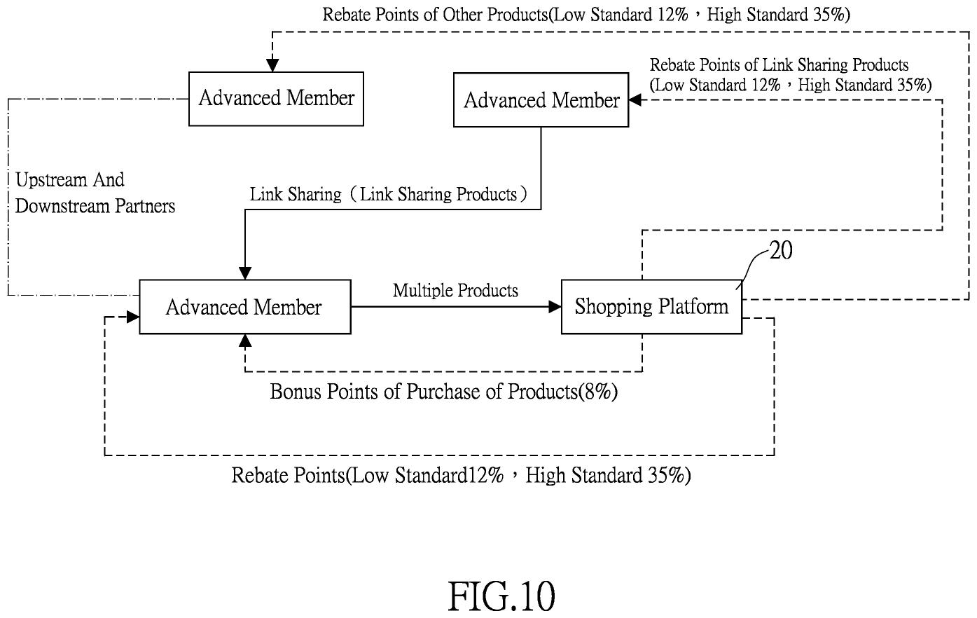

As shown in FIG. 10, when there are three advanced members, and two of the three advanced members are upstream and downstream partners, the third advanced member issues a link sharing to the downstream advanced member, and the downstream advanced member purchases one product of the link sharing product and one product that is involved in the link sharing from the shopping platform 20, the downstream advanced member receives bonus points from the shopping bonus calculation unit 530, and receives rebate points from minimum 12% (30×12%=3.6) to maximum 35% (30×35%=10.5). The advanced member so sends the link sharing receives from minimum 12% (30×12%=3.6) to maximum 35% (30×35%=10.5) from the rebate calculation unit 540. The upstream advanced member receives rebate points from the purchased products that are not involved in the link sharing from minimum 12% (30×12%=3.6) to maximum 35% (30×35%=10.5) from the rebate calculation unit 540. The rebate points are deemed into bonus to the advanced member (the upstream advanced member, the advanced member who sends the link shafting).

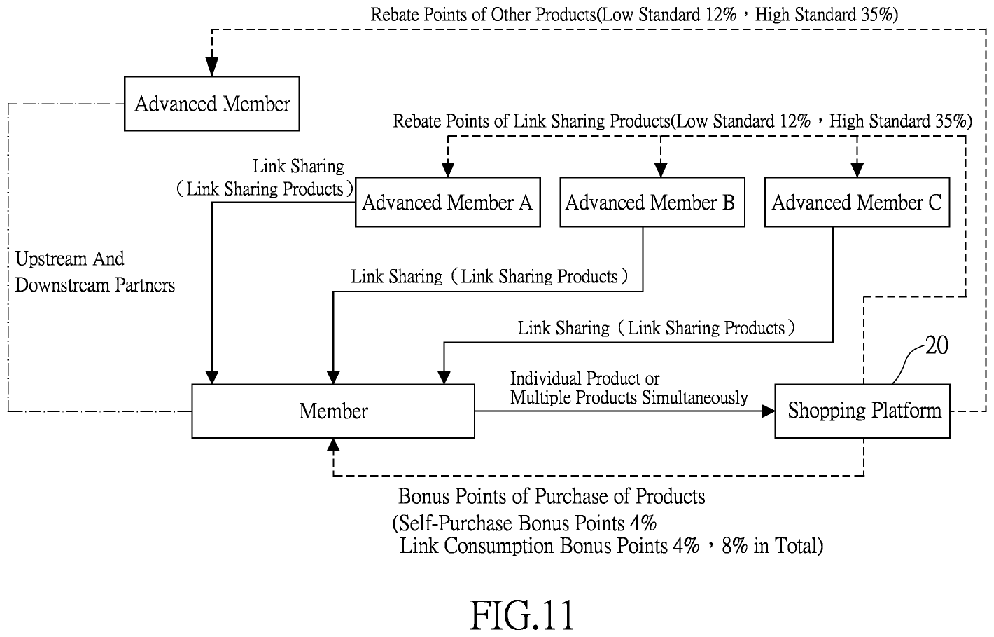

As shown in FIG. 11, when an advanced member and a member are upstream and downstream partners, other three advanced members (A, B, C) issue a link sharing to the downstream member, and the downstream member purchases products each product that is involved in the link sharing, and products that are not involved in the link sharing from the shopping platform 20. The downstream member receives bonus points (300×(4+4)%=24) from the shopping bonus calculation unit 530. The advanced members (A, B, C) issuing a link sharing receives rebate points from the rebate calculation unit 540 from minimum 12% (30×12%=3.6) to maximum 35% (30×35%=10.5). The upstream advanced member receives rebate points from the rebate calculation unit 540 from minimum 12% (30×12%=3.6) to maximum 35% (30×35%=10.5). The rebate points are deemed into bonus to the advanced member (the upstream advanced member, the advanced member who sends the link shafting).

While we have shown and described the embodiment in accordance with the present invention, it should be clear to those skilled in the art that further embodiments may be made without departing from the scope of the present invention.

What is claimed is:

1. A shopping platform profit sharing system (1), comprising a user end (200) and a server (300), wherein the user end (200) and the server (300) are connected with each other by internet (10) so as to transmit data to each other, the server (300) comprises a database (400) and a transaction management module (500), the database (400) comprises a product information (410), a member information (420) and a link sharing generation unit (430), the member information (420) comprises member information and advanced member information, the advanced member and some of the members are upstream and downstream partners, the advanced member and the rest of the members are not upstream and downstream partners, the members are not upstream and downstream partners;
the transaction management module (500) comprises an identity verification unit (510), a link sharing confirmation unit (520), a shopping bonus calculation unit (530), and a rebate calculation unit (540), the members and the advanced members directly registered on the shopping platform, only the members and the advanced members being allowed to put orders and purchase product from the shopping platform profit sharing system, and
when the user end (200) places an order to purchase a product by the transaction management module (500), the order is checked, calculated and delivered through the identity verification unit (510), the link sharing confirmation unit (520), the shopping bonus calculation unit (530) and the rebate calculation unit (540), when the user end (200) is a member, the identity verification unit (510) confirms whether the user end (200) matches with the member information, the link sharing confirmation unit (520) confirms the match, the shopping bonus calculation unit (530) issues and adds a bonus point to the member information; and when the user end (200) is an advanced member, the identity verification unit (510) confirms whether the user end (200) matches with the advanced member information, the link sharing confirmation unit (520) confirms the match, and the shopping bonus calculation unit (530) and the rebate calculation unit (540) issue and add a bonus point and a rebate point to the advanced member information, the bonus points are redeemed when purchasing products on the shopping platform next time.

2. The shopping platform profit sharing system according to claim 1, wherein when the member is not granted by the link sharing confirmation unit (520), the member receives a self-purchase bonus point from the shopping bonus calculation unit (530), when the advanced member and the member are upstream and downstream partners, the advanced member receives the rebate point from the rebate calculation unit (540).

3. The shopping platform profit sharing system according to claim 1, wherein when the advanced member operates the user end (200) at the link sharing generation unit (430) to generate a product link sharing including the product information and the advanced member information, the advanced member shares product link sharing with members of other user ends (200) via the internet (10).

4. The shopping platform profit sharing system according to claim 3, wherein when the member is matched by the link sharing confirmation unit (520), the member receives a self-purchased bonus point and a link consumption bonus point from the shopping bonus calculation unit (530), when the advanced member and the member are upstream and downstream partners, the advanced member receives the rebate point from the rebate calculation unit (540).

5. The shopping platform profit sharing system according to claim 1, wherein when the member is matched by the link sharing confirmation unit (520), the member receives a self-purchased bonus point and a link consumption bonus point from the shopping bonus calculation unit (530), when the advanced member and the member are not upstream and downstream partners, the advanced member receives a rebate point from the rebate calculation unit (540).

6. The shopping platform profit sharing system according to claim 1, wherein when the advanced member is matched by the link sharing confirmation unit (520), the advanced member receives self-purchased bonus points from the shopping bonus calculation unit (530), the advanced member receives rebate points from the rebate calculation unit (540).
